(19) United States
(12) Patent Application Publication
(10) Pub. No.: US 2015/0110707 A1
(43) Pub. Date: Apr. 23, 2015

(54) PROCESS FOR MAKING CHEMICALLY ACTIVATED CARBON

(71) Applicant: Corning Incorporated, Corning, NY (US)

(72) Inventors: Kishor Purushottam Gadkaree, Painted Post, NY (US); Jia Liu, Painted Post, NY (US)

(73) Assignee: Corning Incorporated, Corning, NY (US)

(21) Appl. No.: 14/161,226

(22) Filed: Jan. 22, 2014

Related U.S. Application Data
(60) Provisional application No. 61/894,100, filed on Oct. 22, 2013.

(51) Int. Cl. C01B 31/12

(52) U.S. Cl. CPC C01B 31/12
USPC 423/460; 423/445 R

(57) ABSTRACT

A method for making activated carbon includes heating a mixture of a carbon precursor or a carbonized precursor and a chemical activating agent in a furnace. The furnace includes an internal surface either formed from or lined with a corrosion resistant material such as high purity silicon carbide or silicon nitride.

### CROSS-REFERENCE TO RELATED APPLICATIONS

This application claims the benefit of priority under 35 U.S.C. §119 of U.S. application Ser. No. 61/894,100 filed on Oct. 22, 2013, the entire content of which is hereby incorporated by reference.

### BACKGROUND

1. Field

The present disclosure relates generally methods for forming activated carbon, and more specifically to carbon activation methods using corrosion resistant apparatus.

2. Technical Background

Activated carbon can be incorporated into carbon-based electrodes of energy storage devices such as electrochemical double layer capacitors (EDLCs), aka ultracapacitors. The achievable energy density and powder density of such devices are largely determined by the properties of the carbon-based electrodes and, thus, by the properties of the activated carbon used to form the electrodes.

Activated carbon may be produced by physical or chemical activation routes. The latter uses corrosive chemical activating agents. It would be advantageous to provide apparatus and methods for forming activation carbon economically and possessing the desired properties.

### BRIEF SUMMARY

In accordance with embodiments of the present disclosure, a method for making activated carbon comprises heating a mixture comprising a carbon precursor or a carbonized precursor and a chemical activating agent in a furnace, wherein the furnace includes an internal surface formed from or lined with a corrosion resistant material selected from the group consisting of silicon carbide and silicon nitride. In addition to inhibiting corrosive damage to the furnace, the corrosion resistant material mitigates contamination of the activated carbon (e.g., by minimizing the formation—and incorporation into the activated carbon—of corrosion by-products).

Additional features and advantages of the subject matter of the present disclosure will be set forth in the detailed description which follows, and in part will be readily apparent to those skilled in the art from that description or recognized by practicing the subject matter of the present disclosure as described herein, including the detailed description which follows, the claims, as well as the appended drawings.

It is to be understood that both the foregoing general description and the following detailed description present embodiments of the subject matter of the present disclosure, and are intended to provide an overview or framework for understanding the nature and character of the subject matter of the present disclosure as it is claimed. The accompanying drawings are included to provide a further understanding of the subject matter of the present disclosure, and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a schematic diagram of a furnace comprising a corrosion-resistant material according to one embodiment; and

FIG. 2 is a schematic diagram of a furnace comprising a corrosion-resistant liner.

### DETAILED DESCRIPTION

Reference will now be made in greater detail to various embodiments of the subject matter of the present disclosure, some embodiments of which are illustrated in the accompanying drawings. The same reference numerals will be used throughout the drawings to refer to the same or similar parts.

The performance of an energy storage device comprising carbon-based electrodes is largely determined by the physical and chemical properties of the activated carbon. Physical properties include surface area, pore size and pore size distribution, and pore structure, which includes such features as pore shape and interconnectivity. Chemical properties refer mainly to bulk and surface impurities, the latter relating particularly to the type and degree of surface functionalization.

High performance activated carbon, which forms the basis of the electrodes, can be made from natural and/or synthetic carbon precursors via carbonization and then activation of the carbon source. For example, activated carbon can be made by initially heating a natural or synthetic carbon precursor in an inert environment at a temperature sufficient to carbonize the precursor. During the carbonization step, the carbon precursor is reduced or otherwise converted to elemental carbon. Following the process of carbonization, the carbonized material can be activated. During the activation step, the elemental carbon produced during the carbonization step is processed to increase its porosity and/or internal surface area. An activation process can comprise chemical activation.

As an alternative to activating previously-carbonized material, a chemical activating agent can be combined with a carbon precursor and the resulting mixture can be heat-treated to affect carbonization and activation in a combined (e.g., simultaneous) step.

Examples of suitable carbon precursors include wheat flour, walnut flour, corn flour, corn starch, corn meal, rice flour, potato flour, beets, millet, soybean, barley, cotton, charcoal, coal, coke, nut shells, coconut shells, woods, and biomass. Examples of suitable synthetic carbon precursors, which generally yield higher purity carbon material than non-synthetic carbon precursors, include polymers such as phenolic resins, poly(vinyl alcohol) (PVA), polyacrylonitrile (PAN), etc.

Chemical activating agents such as potassium hydroxide (KOH) can be combined with the carbon precursor and then heated at a temperature ranging from about 500-1000° C. In addition to potassium hydroxide, chemical activating agents may also include K₂CO₃, KCl, NaOH, Na₂CO₃, NaCl, AlCl₃, ZnCl₂, MgCl₂, H₃PO₄ and P₂O₅.

Prior to carbonization and activation, a carbon precursor (e.g., resinous precursors) may be cured. By curing is meant a heating cycle that at least partially cross-links or polymerizes a carbon precursor to form a viscous or solid material. A chemical activating agent may be combined with a carbon precursor prior to or following a curing step.

As used herein, a “heating cycle” comprises a heat-up step, a hold step at a target temperature, and a cool-down step. In various embodiments, heating cycles may affect “curing,” “carbonization,” and “activation.” These cycles may be carried out successively or in various combination(s) in various embodiments. For example, a curing cycle may precede a combined carbonization/activation cycle.

A curing cycle, if used, can comprise heating a carbon precursor or a mixture of a carbon precursor and a chemical activating agent at a temperature in the range of about 100-300° C. for a period of about 1-48 hours. During the heat-up, hold, and cool-down, the mixture is preferably maintained in a reducing or inert environment. One or more reducing gases (e.g., H₂, H₂/N₂ mixtures, CO) and/or one or more inert gases (e.g., N₂, He, Ar) can be used.

In embodiments, a chemical activating agent is homogeneously mixed and incorporated throughout the carbon precursor at a molecular level prior to curing. In such an example, the chemical activating agent in the form of a solution can be combined with the carbon precursor. This facilitates molecular level mixing of the chemical activating agent with the carbon precursor, which promotes a homogeneous activated carbon that comprises a uniform distribution of physical characteristics (pore size, pore size distribution, and pore structure etc.). A solution of a chemical activating agent can be an aqueous or non-aqueous solution.

Carbonization and activation may be performed by heat-treating a mixture of a carbon precursor and a chemical activating agent. The mixture may be a dry mixture or a wet mixture. A wet mixture may comprise a slurry or a suspension, for example.

Carbonization and activation may be performed by heating the mixture at a temperature in the range of 400° C.-1000° C. for a period of 0.5 to 10 hr. The heating and cooling rates for both the curing cycle, if used, and the carbonization/activation cycle can range from about 10-600° C./hr. The carbonization and activation cycle can be performed using an inert or reducing environment.

In the above carbonization/activation process, various gases (including water, hydrogen, methane, carbon dioxide, carbon monoxide, and various volatile organic compounds) are generated from decomposition of organic molecules and their reactions with KOH and other derived potassium species.

The carbon precursor and a chemical activating agent can be combined in any suitable ratio. The specific value of a suitable ratio may depend on the physical form of the carbon precursor and the chemical activating agent. A ratio of carbon precursor to chemical activating agent on the basis of dry material weight can range from about 1:10 to 10:1. For example, the ratio can be about 1:1, 1:2, 1:3, 1:4, 1:5, 5:1, 4:1, 3:1, 2:1 or 1:1. As an alternative to combining a solution of a chemical activating agent with a carbon precursor, the chemical activating agent can be mixed with the carbon precursor in solid (e.g., powder) form.

Whether a chemical activating agent is combined with a carbon precursor in solid form or using a solution of the chemical activating agent, the mixture may be carbonized and activated in a single heating cycle. This so called “one-cycle” process is simple and convenient. However, aspects of a “one-cycle” carbonization/activation process may limit large-scale production of activated carbon material due to economic considerations.

Particularly in embodiments where sodium or potassium salts or bases are used as the chemical activating agent, a large volume of gas can be generated by various chemical reactions that occur at intermediate temperatures during the carbonization/activation heating cycle. The large gas volume can cause foaming of the intermediate product, resulting in a volume expansion of a factor as high as 30-40. This gas production and the concomitant foaming effectively limit the amount of starting material that can be processed in a furnace of a given volume.

When using a chemical activating agent comprising a sodium or potassium salt or base, an additional consideration is the possibility that elemental sodium or potassium can be produced as a by-product of reactions between organic molecules (and/or organic functional groups on carbon) and the activating agent. Metallic sodium and metallic potassium are each very reactive and can explode when exposed to air or moisture. Because these alkaline metals can vaporize and re-deposit in the furnace during the elevated processing temperatures associated with carbonization/activation, the furnace should be built corrosion-resistant and configured to ensure safe operation. This will further increase equipment cost and capital investment.

When taken together, these two factors may limit the utilization of furnace capacity and capital investment. On the one hand, out-gassing during carbonization/activation suggests that larger volume furnaces would be useful in order to accommodate the foamed carbon precursor. On the other hand, the formation of alkaline metals such as sodium or potassium during carbonization/activation suggests that the furnaces should be fitted with additional features to properly address corrosion and hazard concerns, which adversely affects cost.

A method for making activated carbon comprises heating a mixture comprising a carbon precursor or a carbonized carbon precursor and a chemical activating agent in a furnace, wherein the furnace includes an internal surface formed from or lined with a corrosion resistant material.

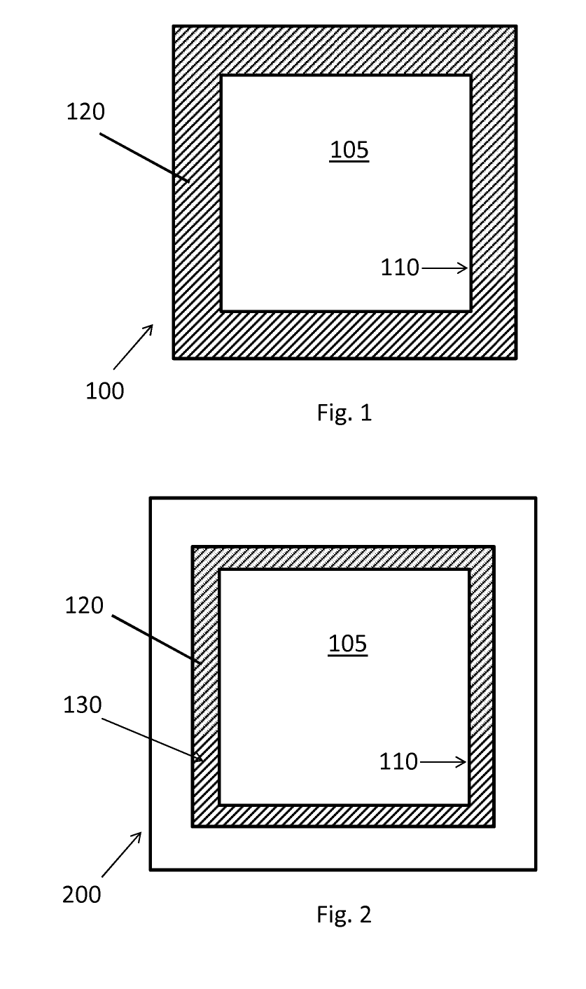

An example furnace 100 having an internal region 105 and internal surface 110 formed from a corrosion-resistant material 120 is shown schematically in FIG. 1. According to further embodiments, an example furnace 200 having an internal surface 110 lined with a corrosion-resistant material 120 is shown schematically in FIG. 2. The liner 130 thickness may be 100 to 1000 microns or more.

In embodiments, following carbonization and activation, once the furnace temperature has cooled, a purge gas (such as N₂) saturated with water vapor can be introduced into the furnace. This step of introducing water-saturated N₂ to the furnace interior allows any metallic potassium that has been produced during the heating cycle to react with water vapor and form KOH. Without this step, metallic potassium could self-ignite and possibly explode when exposed to oxygen.

In embodiments, the N₂/water vapor purge is continued for 1-3 hours before the furnace is opened and unloaded. The activated carbon product can then be washed in DI water and/or steam to remove excess, unreacted activating agent and activating agent by-products from the activated carbon. In embodiments, the washing comprises rinsing the activated carbon material first with de-ionized water, then an aqueous acid solution, and then de-ionized water. Finally, the activated carbon can be dried (e.g., overnight at 110° C. in a vacuum oven) and ground to the desired particle size (typically several micrometers).

Activated carbon produced by this method offers significantly higher energy storage capacity in EDLCs compared to major commercial carbons. In addition to its use in energy storage devices, such activated carbon can be used as a catalyst support or as media for adsorption/filtration.

In order to address the corrosive nature of the chemical activation process, high-purity refractory materials such as silicon carbide and silicon carbide were investigated as candidate furnace materials. The internal surface(s) of the furnace can be constructed of, or lined with, a corrosion-resistant material.

The corrosion-resistant material can decrease long-term capital costs by extending the service life of the furnace equipment. Also, the corrosion-resistant material can forestall the creation of impurities, which may otherwise degrade the activated carbon. In particular, silicon carbide is compatible with induction or microwave heating in addition to electrical or gas heating.

The corrosion resistance of high-purity silicon carbide exposed to various aqueous chemical activating agents is summarized in Table 1. Example chemical activating agents include alkali materials such as NaOH and KOH, and acid materials including H₃PO₄. Samples exhibiting a corrosive weight loss in excess of 1000 mg/cm²yr were essentially completely destroyed in less than one week. Materials exhibiting a corrosive weight loss of less than 10 mg/cm²yr are suitable for long-term service.

TABLE 1
Corrosion Behavior of Candidate Materials

| Test Conditions | | Weight Loss [mg/cm²yr] | | | |
|---|---|---|---|---|---|
| Reagent | Temp | SiC (no | Rxn bonded SiC | | |
| [wt. %] | [° C.] | free Si) | (12% Si) | WC (6% Co) | Al₂O₃ |
| 50% NaOH | 100 | 2.5 | >1000 | 5 | 75 |
| 45% KOH | 100 | <0.2 | >1000 | 3 | 60 |
| 85% H₃PO₄ | 100 | <0.2 | 8.8 | 55 | >1000 |

Referring still to Table 1, and without wishing to be bound by theory, the alkali hydroxides (NaOH and KOH) induce significantly more corrosion than phosphoric acid. Notwithstanding the test conditions summarized in Table 1, chemical activation using H₃PO₄ is typically carried out at a process temperature of 400-600° C. while chemical activation using NaOH or KOH is typically carried out at a process temperature of 600-1000° C. In particular, NaOH or KOH-based activation may further involve the generation of metallic sodium or metallic potassium, which are highly corrosive.

Corrosion-resistant materials are advantageously dense. Example corrosion-resistant materials are at least 95% dense, e.g., at least 95, 96, 97, 98, 99 or 100% dense (i.e., with respect to a theoretical density). Silicon carbide (e.g., SiC) when used as a corrosion-resistant material can have a density of at least 3.0 g/cm³ (e.g., at least 3.0, 3.05, 3.1, 3.15 or 3.2 g/cm³). Silicon nitride (e.g., Si₃N₄) when used as a corrosion-resistant material can have a density of at least 3.0 g/cm³ (e.g., at least 3.0, 3.05, 3.1, 3.15 or 3.2 g/cm³). Corrosion-resistant materials can be polycrystalline and have an average grain size, for example, of less than 20 microns, e.g., less than 20, 10 or 5 microns. In embodiments, a corrosion-resistant material is a single-phase material being free of inclusions or phase-separated regions. Single-phase silicon carbide, for example, contains no free silicon (i.e., no elemental silicon).

### EXAMPLES

### Example 1

Chemical activation was conducted in a box furnace (CM Furnaces, model 1216FL) with an Inconel 600 retort. A mixture comprising a carbon precursor and KOH was contained in a crucible made of SiC. The furnace was heated to a temperature of 600-1000° C. under a N₂ purge before being cooled to room temperature.

After tens of process cycles, there was no significant corrosion or damage to the SiC crucible which was in direct contact with the batch material while the metal retort, exposed only via the gas phase, showed significant scaling due to corrosion. Further, flakes of the corroded metal fell into the activation batch, resulting in high levels of iron, nickel, and chromium contamination, which are detrimental to the long term stability of EDLC cells.

### Example 2

### Box Furnace

A liner made of SiC plate was installed in the furnace of Example 1 to protect the metal retort. As a result, corrosion to the metal retort was significantly impeded and metal contamination in the carbon product as a result of corrosion was eliminated.

### Example 3

### Rotary Furnace

Chemical activation was conducted in a rotary furnace with a heating zone and a cooling zone. The internal surfaces were lined with SiC where direct or indirect exposure to the batch material is expected.

### Example 4

### Gravity-Fed Furnace

Chemical activation was conducted in a 4-zone, gravity-fed furnace. Heating zone 1 includes an inclined plane that is made of, or lined with, SiC. A target temperature T1 is achieved in heating zone 1, for example, using microwave or induction heating (where the SiC acts as a susceptor), or by gas or electric heating, or a combination of these heating methods. A temperature T1 in heating zone 1 can be in the range of 300-600° C.

In an example method, a powder mixture of KOH and carbon is introduced at the top of the inclined plane. As the KOH is melted, the mixture flows down the inclined plane. Water is removed from the batch and some initial reactions between KOH and carbon may take place depending on the actual temperature. At the bottom of the plane, transition zone (zone 2) is optionally lined with SiC, where the melted batch material can be cooled to a temperature T2 (<T1) to allow solidification.

The solidified material is fed into heating zone 3, which is heated to a temperature T3, which can be in the range of 600-1000° C. The carbon is activated in heating zone 3. Due to the pre-treatment (e.g., curing) in heating zone 1, minimal foaming occurs in heating zone 3. Heating zone 3 can have a batch furnace of a continuous furnace design, for example a rotary furnace, Lehr furnace, pusher kiln, etc. The activated carbon can be cooled in zone 4.

As used herein, the singular forms “a,” “an” and “the” include plural referents unless the context clearly dictates otherwise. Thus, for example, reference to a “chemical activating agent” includes examples having two or more such “chemical activating agents” unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It is also noted that recitations herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a batch formulation that comprises a carbon precursor and a chemical activating agent include embodiments where a batch formulation consists a carbon precursor and a chemical activating agent and embodiments where a batch formulation consists essentially of a carbon precursor and a chemical activating agent.

It will be apparent to those skilled in the art that various modifications and variations can be made to the present invention without departing from the spirit and scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

1. A method for making activated carbon, comprising:
heating a mixture comprising a carbon precursor or a carbonized precursor and a chemical activating agent in a furnace to form activated carbon, wherein an internal surface of the furnace is formed from or lined with a corrosion resistant material selected from the group consisting of silicon carbide and silicon nitride and during the heating the internal surface is exposed to the mixture.

2. The method according to claim 1, wherein the carbon precursor is selected from the group consisting of wheat flour, walnut flour, corn flour, corn starch, corn meal, rice flour, potato flour, beets, millet, soybean, barley, cotton, coconut shells, charcoal, coal, coke, phenolic resins, poly(vinyl alcohol), and polyacrylonitrile.

3. The method according to claim 1, wherein the chemical activating agent is selected from the group consisting of KOH, K₂CO₃, KCl, NaOH, Na₂CO₃, NaCl, AlCl₃, ZnCl₂, MgCl₂, H₃PO₄ and P₂O₅.

4. The method according to claim 1, wherein the heating comprises forming an intermediate carbon product from the carbon precursor in a first heating cycle and forming activated carbon from the intermediate carbon product in a second heating cycle.

5. The method according to claim 4, wherein the first heating cycle comprises heating the mixture to a temperature in a range of 300° C. to 600° C.

6. The method according to claim 4, wherein the second heating cycle comprises heating the intermediate carbon product to a temperature in a range of 500° C. to 1000° C.

7. The method according to claim 4, further comprising cooling the intermediate product to less than 30° C. between the first heating cycle and the second heating cycle.

8. The method according to claim 4, wherein the intermediate carbon product comprises a foamed carbon precursor that is at least partially converted to carbon.

9. The method according to claim 1, wherein the activated carbon is ground to form a powder.

10. The method according to claim 1, wherein the furnace is purged with N₂ saturated with water vapor prior to removing the activated carbon from the furnace.

11. The method according to claim 1, further comprising washing the activated carbon.

12. The method according to claim 11, wherein the washing comprises the sequential acts of:
washing the activated carbon with de-ionized water;
washing the activated carbon with an aqueous acid solution; and
washing the activated carbon with de-ionized water,
wherein the second washing with a source of de-ionized water is carried out until the effluent has a pH substantially equal to the source of de-ionized water.

13. The method according to claim 1, wherein the corrosion resistant material is at least 95% dense.

14. The method according to claim 1, wherein the corrosion resistant material is at least 98% dense.

15. The method according to claim 1, wherein the corrosion resistant material is silicon carbide having a density of at least 3.0 g/cm³.

16. The method according to claim 1, wherein the corrosion resistant material is silicon nitride having a density of at least 3.0 g/cm³.

17. The method according to claim 1, wherein the corrosion resistant material is silicon carbide having an average grain size of less than 20 microns.

18. The method according to claim 1, wherein the corrosion resistant material is silicon carbide having no free silicon.

19. The method according to claim 1, wherein the mixture comprises a slurry or a suspension.
